(19) United States
(12) Patent Application Publication
(10) Pub. No.: US 2023/0402750 A1
(43) Pub. Date: Dec. 14, 2023

(54) REFLECTARRAY AND METHOD THEREFOR

(71) Applicant: Metawave Corporation, Carlsbad, CA (US)

(72) Inventors: Taha Shahvirdi Dizaj Yekan, San Diego, CA (US); Maha Achour, Encinitas, CA (US)

(21) Appl. No.: 18/249,102

(22) PCT Filed: Oct. 14, 2021
(86) PCT No.: PCT/US2021/055067

§ 371 Date: Apr. 14, 2023

Related U.S. Application Data
(60) Provisional application No. 63/091,776, filed on Oct. 14, 2020.

(51) Int. Cl. H01Q 3/46

(52) U.S. Cl. CPC H01Q 3/46

(57) ABSTRACT

A reflectarray for an antenna system for use in wireless communications is described. The reflectarray includes a substrate and a plurality of cells configured in an array on the substrate. Each cell in the plurality of cells includes three dipoles arranged in a parallel configuration with a length of a center dipole is longer than a length of a lateral dipole. The length of the lateral dipole is 65% of the length of the center dipole. The plurality of cells can include a first set of three parallel dipoles arranged in a first direction and a second set of three parallel dipoles in a second direction that is orthogonal to the first direction. The first set of three parallel dipoles and the second set of three parallel dipoles are shifted half a period along both the first direction and the second direction in the array.

### CROSS-REFERENCE TO RELATED APPLICATIONS

This application claims priority from U.S. Provisional Application No. 63/091,776, filed on Oct. 14, 2020, which is incorporated by reference in its entirety.

### BACKGROUND

The Fifth Generation of mobile communications (5G) has boosted the use of higher frequency bands in the millimeter-wave spectrum, such as 28 GHz, 39 GHz, and 60 GHz, to provide high-speed wireless access in cellular network. One of the challenges of millimeter-wave 5G communications is related with the signal propagation at those frequencies, which is characterized by a larger path loss and higher sensitivity to physical barriers. The coverage provided by the base station antenna may be disrupted by buildings (in outdoor scenarios), walls (in indoor scenarios) or other structures, resulting in blind zones. One or more of these challenges need to be resolved before 5G communications protocol can be widely adopted in wireless networks. Therefore, there is a need for an improved method and/or apparatus that is capable of resolving the current challenges facing signal propagation at the millimeter-wave frequencies.

### BRIEF DESCRIPTION OF THE DRAWINGS

The present application may be more fully appreciated in connection with the following detailed description taken in conjunction with the accompanying drawings, which are not drawn to scale, in which like reference characters refer to like parts throughout, and in which:

FIG. 1 illustrates a reflectarray (RA) in a wireless communications environment, in accordance with various embodiments of the subject technology;

FIGS. 2A and 2B illustrate geometric measures of the reflectarray of FIG. 1, in accordance with various embodiments of the subject technology;

FIGS. 3A and 3B illustrate a reflectarray in top view and cross-section view, respectively, in accordance with various embodiments of the subject technology;

FIGS. 4A and 4B illustrate plot diagrams of phase and amplitude curves as a function of the dipole length for the V-polarization and H-polarization for a given reflectarray cell (e.g., the reflectarray configuration 300 of FIGS. 3A and 3B), in accordance with various implementations of the subject technology;

FIG. 5 illustrates example results of a phase-only pattern synthesis of a reflectarray, in accordance with various implementations of the subject technology;

FIGS. 6A and 6B illustrate radiation patterns in azimuth and elevation planes of a reflectarray, in accordance with various implementations of the subject technology;

FIGS. 7A and 7B illustrate radiation patterns in azimuth and elevation planes of a reflectarray at different operating frequencies, in accordance with various implementations of the subject technology; and

FIG. 8 illustrates a flowchart for a process of designing a reflectarray, in accordance with one or more implementations of the subject technology.

### DETAILED DESCRIPTION

The present disclosure relates to methods and apparatuses of a reflectarray (RA), and the design thereof, that can improve coverage in 5G cellular networks. The RA of the present disclosure is designed to exhibit stable behavior within a specific frequency band and is particularly applicable to millimeter-wave 5G communications. The disclosed reflectarray (passive shaped beam) can be deployed in an antenna system for wireless communications, in accordance with various embodiments and implementations. RA-based antennas (e.g., passive RAs) can drastically improve coverage in millimeter-wave spectrum. Passive RAs can be designed to produce a shaped or a contoured beam with the additional advantages of their flat profile, lightweight, and a simpler and cheaper manufacturing process than shaped metallic reflectors.

The disclosed RA can be designed to produce a broadened and deflected beam in dual-linear polarization (e.g., horizontal and vertical linear polarizations) at various frequencies, including for example, but not limited to, 28 GHz, 39 GHz, and 60 GHz. The disclosed RA (unit cell) can provide a range of phase variations and a robust performance under large angles of incidence. In various embodiments, a phase-only synthesis can be applied to obtain phase distribution on the RA to fulfill various requirements within the confine of the 5G cellular networks. For example, an RA can be designed to concentrate the power received from a base station (BS) in a specific area in order to enhance wireless access for users located in that area. In most wireless networks, an RA is designed to able to produce a shaped beam and to deflect the beam in a specific direction based on preset requirements determined by individual use-case scenarios, one of which is illustrated and described below.

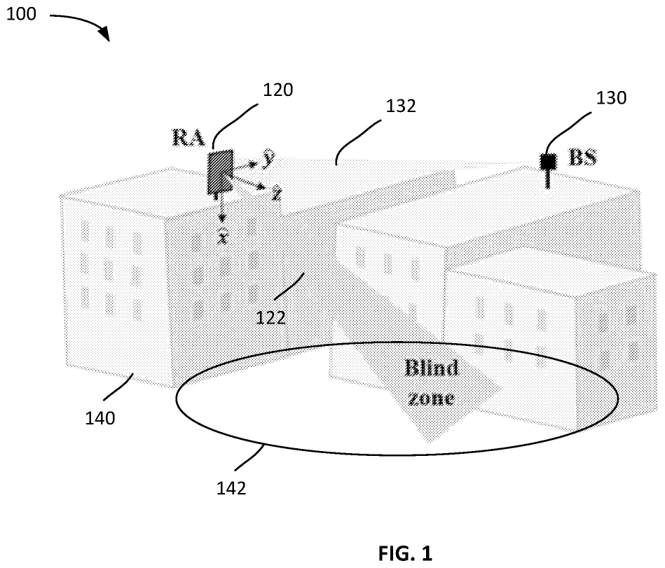

FIG. 1 illustrates a reflectarray (RA) in an example wireless communications environment, in accordance with various embodiments of the subject technology. FIG. 1 illustrates a typical 5G outdoor scenario 100 with a reflectarray (RA) 120 receiving incident electromagnetic beams or is illuminated by a base station (BS) 130 to enhance coverage in a blind zone 142. The scenario 100 includes several buildings, such as a building 140, in a geographical configuration as illustrated in FIG. 1. From the perspective of BS 130, the blind zone 142 is considered a non-line of sight (NLOS) area indicated along a reflected beam 122 from the RA 120 and an incident beam 132 from BS 130 is considered part of the line of sight (LOS) zone. The RA 120 illustrated in FIG. 1 is a passive shaped-beam RA designed to improve coverage in a conventional 5G outdoor scenario. The RA 120 is able to generate a broadened and deflected beam in dual-linear polarization (e.g., both horizontal and vertical polarization), showing a robust performance within a given frequency band, for example 27.2-28.2 GHz band, despite of the large incidence angles from the BS 130.

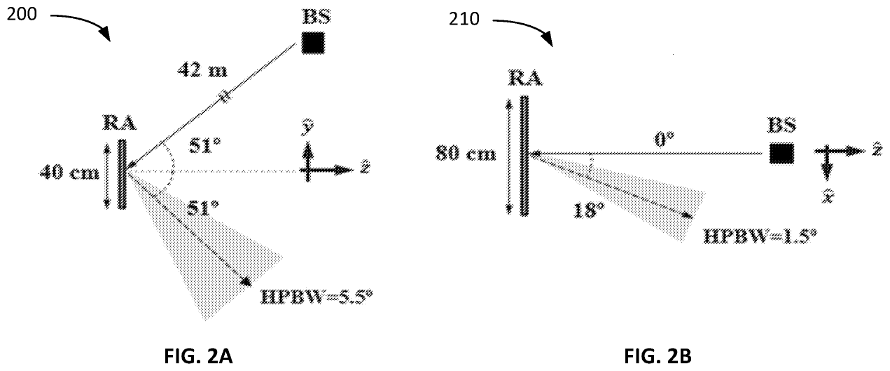

An example 5G scenario 100 illustrated in FIG. 1 is further described with specific dimensions for clarity of understanding. This example is not to be limiting but rather explanatory. In this particular example, some of the geometric parameters of the environment 100 are described with respect to FIGS. 2A and 2B. In this non-limiting example, the dimensions of the RA, more specifically RA panel, are 80 cm×40 cm. The RA 120 is illuminated by the BS 130 antenna, which is located at a distance of, for example, 42 m, forming an angle of 51° in the azimuth, or horizontal, plane, as illustrated in FIGS. 2A and 2B. Note that the RA 120 and the BS 130 are at the same height. To improve coverage in the blind zone 142, the beam is radiated at an angle of 51° in azimuth and 18° in elevation, and it presents a half power beamwidth (HPBW) of 5.5° in azimuth and 1.5° in elevation. For comparison, a conventional RA with the same dimensions of 80 cm×40 cm designed to produce a collimated beam in the same direction would present a HPBW of 2° in azimuth and 0.7° in elevation. As improvement compared to the conventional RA, the RA 120 of the present disclosure broadens the incident beam 132 by a factor larger than 2 in both azimuth and elevation, vertical, planes, and deflects the beam 18° in elevation with respect to the specular direction of the BS 130.

Continuing with this example, the geometries of the 5G environment of FIG. 1 with RA 120 and BS 130 are illustrated in azimuth graph 200 of FIG. 2A and elevation graph 210 of FIG. 2B. The graphs show that the large distance between the RA 120 and the BS 130 results in a small variation of the incidence angles (θᵢ, φᵢ) on the RA cells. In the geometries shown in FIGS. 2A and 2B, the maximum variation of θᵢ is less than ±0.3° with respect to 51°, while φᵢ varies between 89.3° and 90.7° (note that the x-axis is used as reference for φᵢ=0°). An important improvement in 5G and various directed beam systems includes achieving polarization diversity with conventional antenna performance that is the same for both Horizontal (H) and Vertical (V) linear polarizations, which leads to a large incidence angles on the RA. It is therefore more difficult to achieve polarization diversity for a more comprehensive system. The embodiments and implementations of the technologies disclosed in the present disclosure overcome these and other deficiencies through the use of the RA cell and technologies disclosed in this application.

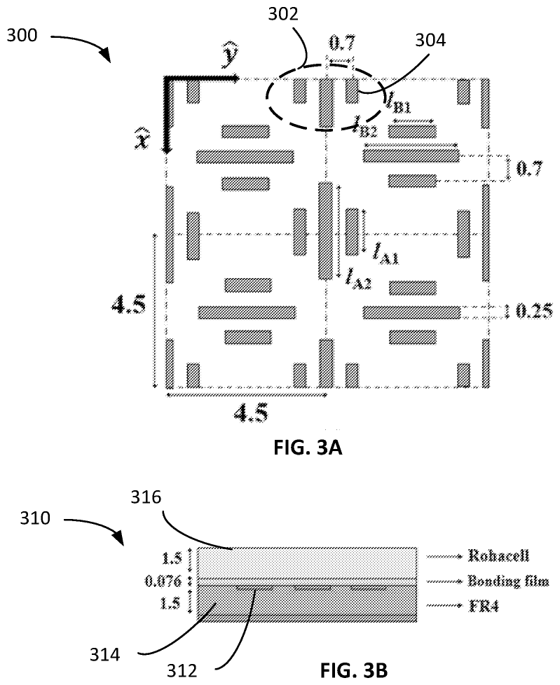

FIGS. 3A and 3B illustrate an example reflectarray (RA) 300 in top view and cross-section view, respectively, in accordance with various embodiments of the subject technology. The RA 300, which is illustrated as unit cells in FIG. 3A, is designed to work in a specific frequency band or multiple bands, such as, for example, but not limited to, the 27.2-28.2 GHz band, and to provide the same performance in V and H polarizations under large incidence angles (θᵢ around 50°). As illustrated in FIG. 3A, the unit-cell dimensions are 4.5 mm×4.5 mm, which is less than 0.5)\, at the operating frequencies of the antenna at approximately 28 GHz. In various embodiments and implementations, the unit-cell dimensions can range from about 3 mm to about 9 mm in a first dimension (e.g., x-axis or x-direction) and about 3 mm to about 9 mm in a second dimension (e.g., y-axis or y-direction). Unit cells with the above dimensions can be implemented to operate at operating frequencies of the antenna at about 10 GHz—about 100 GHz. The RA cells 302 for controlling each linear polarization are made up of three parallel dipoles (e.g., 3-dipole configuration), such as 304, oriented in the direction of the x-axis, i.e., a first direction or x-direction (for V-polarization), and/or in the y-axis, i.e., a second direction or y-direction (for H-polarization). The cells (of RA 300) are arranged in such a way that that the dipoles oriented in the y-direction (for H-polarization) are shifted half a period along both the x and y axes with respect to the dipoles (i.e., the 3-dipole configuration) for V-polarization. Alternatively, the cells can be arranged in such a way that that the dipoles oriented in the x-direction (for V-polarization) are shifted half a period along both the x and y axes with respect to the dipoles for H-polarization.

Now referring to FIG. 3B, which illustrates a stack-up configuration 310 of the RA 300 that has dipoles 312 printed on the top of the lower dielectric 314, which can be a substrate, such as a 1.5-mm thick substrate, including any suitable substrate, such as, for example, but not limited to FR4 substrate. The FR4 substrate can include a glass-reinforced epoxy laminate material, or a composite material composed of woven fiberglass cloth with an epoxy resin binder that is flame resistant. The substrate can have a permittivity of 3.6 and a loss tangent of 0.01. In various implementations, the FR4 substrate can be bonded to a 1.5-mm thick Rohacell foam substrate 316 (with permittivity of 1.1 and loss tangent of 0.004) using one layer of CuClad 6250 bonding film (with thickness of 76 μm, permittivity of 2.3 and loss tangent of 0.0013). In various embodiments, a purpose of the upper foam substrate 316 is to protect the printed dipoles 312. The example stack-up configuration illustrated and described with respect to FIGS. 3A and 3B are for illustrative purposes, and therefore non-limiting, since the operating frequency depends on the various parameters of the stack-up configuration.

The geometry of the RA 300 has been adjusted to achieve a broadband performance for large incidence angles (θᵢ, around 50°). In various implementations, the lengths of the dipoles 304 is used to control the phase shift introduced in each linear polarization, keeping a fixed scale factor of 0.65 between the lengths of the central dipoles (1_{A2} and 1_{B2}) and the lateral dipoles (1_{A1} and 1_{B1} of each arrangement, as illustrated in FIG. 3A. The electromagnetic analysis of the cell of RA 300 has been performed by applying an efficient Method of Moments code and assuming that the cell is placed in a periodic environment.

In various embodiments and implementations, the RA 300 can be rectangular or a square shape panel and can comprise 4,356 cells (66 cells along the x-direction and 66 cells along the y-direction) or 31,684 cells (178 cells along the x-direction and 178 cells along the y-direction), or any suitable number of cells depending on the desired configuration of the RA 300 and operating frequencies. The periodicity is 4.5 mm in both x and y-directions, as illustrated in FIG. 3A, which is less than half a wavelength at the working frequency of 27.7 GHz, in order to minimize (or avoid) grating lobes. The reflectarray configuration 300 has a separation of about 0.7 mm between dipoles, while the width of all dipoles is about 0.25 mm, as illustrated in FIG. 3A. In various embodiments and implementations, the separation can be between about 0.5 mm to 1 mm between dipoles and the width of all dipoles can be about 0.1 mm to about 0.5 mm, inclusive of any dimensions therebetween. The dipole lengths are set to 1_{A1}(1_{B1})=0.65*1_{A2}(1_{B2}), e.g., 65% of the longest dipole. In various implementations, the dipole lengths of the lateral dipoles (e.g., lateral dipole 1_{A1} and/or 1_{B1} can be set to anywhere from 20% to 90% (including, e.g., 30% to 80%, 40% to 75%, or 50% to 70%) of the longest dipole (e.g., center dipole 1_{A2} and/or 1_{B2}) in the 3-dipole arrangement (e.g., three parallel dipoles).

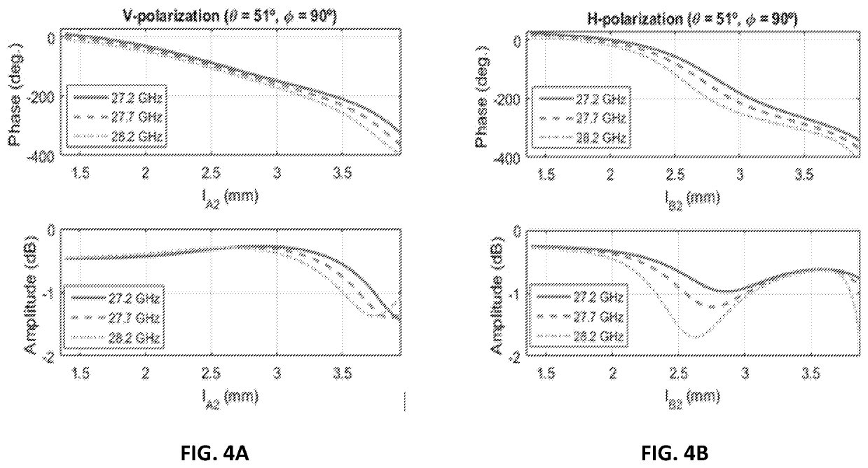

FIGS. 4A and 4B illustrate plot diagrams of phase and amplitude curves as a function of the dipole length (e.g., 1_{A2} and 1_{B2}) for the V-polarization and H-polarization for a given reflectarray cell (e.g., the reflectarray configurations 300 and 310 of FIGS. 3A and 3B) in accordance with various implementations of the subject technology. FIG. 4 is a compilation of plots of phase and amplitude curves of the cell reflection coefficient as a function of the dipole lengths, considering the average incidence angles in the scenario in V-polarization and in H-polarization. In these plots, the reflection coefficient is a function of 1_{A2} (for V-polarization) and 1_{B2} (for H-polarization) at the central and extreme operating frequencies of the RA (27.2, 27.7 and 28.2 GHz), assuming oblique incidence with θᵢ=51°, (φᵢ=90°, which correspond to the average incidence angles of the example of FIGS. 1 and 2. As can be seen in FIGS. 4A and 4B, the range of phase variation is larger than 360° in both polarizations, with a smooth slope of the phase curve. The losses are below 1 dB for most of the dipole lengths.

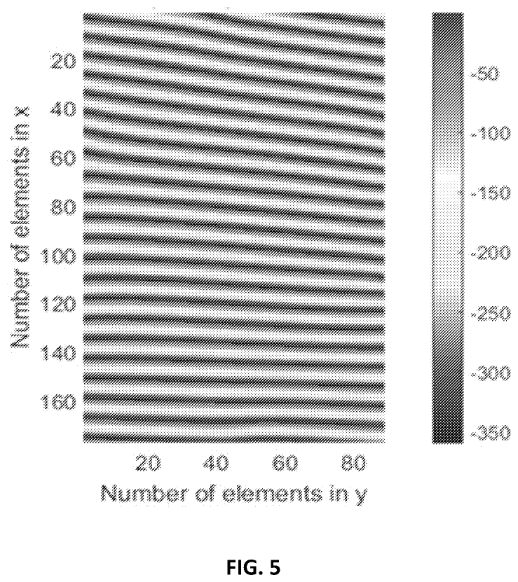

In order to shape the beam both in elevation and azimuth, consider a phase-only pattern synthesis. FIG. 5 illustrates example results of a phase-only pattern synthesis of a reflectarray, in accordance with various implementations of the subject technology. Only the phase shift introduced in each linear polarization is used as the degree of freedom of the problem, which permits independent control of each co-polar component but no control on the cross-polarization introduced by the RA panel. In this case, the generalized intersection approach has been used to synthesize a flat top beam both in azimuth and elevation, being the HPBW covering requirement 5.5° and 1.5° respectively, and the maximum ripple is limited to 3 dB. This algorithm has demonstrated to be very efficient in the synthesis and optimization of RAs with complex beam requirements. Here the coverage requirements are not so complex but still challenging because of the incidence angle and the electrical size of the antenna. The synthesis process has been carried out in several stages to improve the convergence, starting from a pencil beam pointed towards the center of the coverage, which has been obtained with an analytic phase distribution of the reflection coefficient, and introducing in each stage a number of degrees of freedom (RA cells, indicated as number of elements in FIG. 5). This means that the problem in the first stage involves a RA smaller than required and its size is increased up to the final one.

In the case under study, the RA is made up of 178×90 cells (number of elements up to 178 in x and number of elements up to 90 in y as shown in FIG. 5), according to the size of the panel and RA elements defined above. Thus, the final panel includes more than 16,000 periodic cells, which means more than 16,000 degrees of freedom in each polarization for the synthesis algorithm. The final phase shift obtained for V-polarization is given in FIG. 5, where the progressive phase required to tilt the beam can be clearly observed. The beam shaping is performed by the small bends and non-parallel behavior of equal-phase lines. A very similar result is obtained for H-polarization.

The printed elements on the RA have been designed to introduce the phase distributions computed by phase-only synthesis for each linear polarization. The lengths of the x-oriented and y-oriented dipoles have been tuned cell by cell (e.g., at an individual cell basis) to provide phase shifts in two orthogonal polarizations (e.g., required phase shifts in V and H polarizations). The designed RA has been simulated using the abovementioned electromagnetic code based on the Method of Moments and the local periodicity approach.

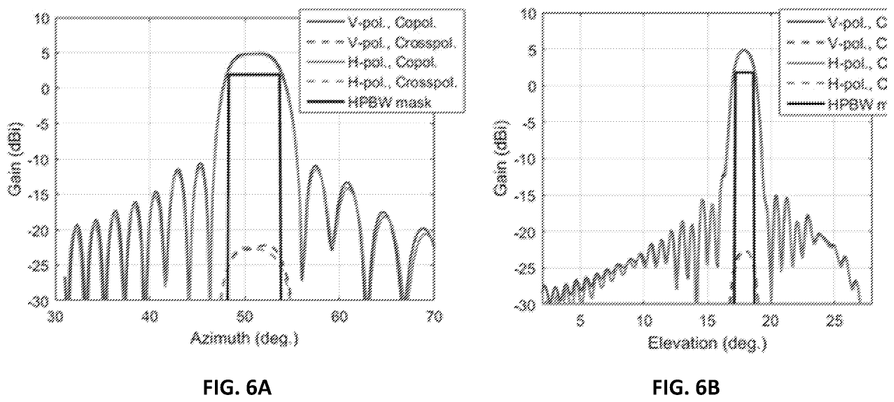

FIGS. 6A and 6B illustrate radiation patterns in azimuth and elevation planes of a reflectarray for a design frequency of, for example, but not limited to, 27.7 GHz in V and H polarizations. To evaluate the compliance with the scenario specifications, FIGS. 6A and 6B include a mask (in black solid line) centered at the beam pointing direction and indicating the required HPBW in each plane. As can be observed, the designed RA fulfills all the requirements concerning beam pointing (51° in azimuth and 18° in elevation) and HPBW (5.5° in azimuth and 1.5° in elevation). The RA exhibits almost the same performance in both linear polarizations, which is an essential requirement to achieve polarization diversity. Moreover, the cross-polar levels are more than 25 dB lower than the co-polar components within the main lobe region, despite of the large incidence angles on the RA.

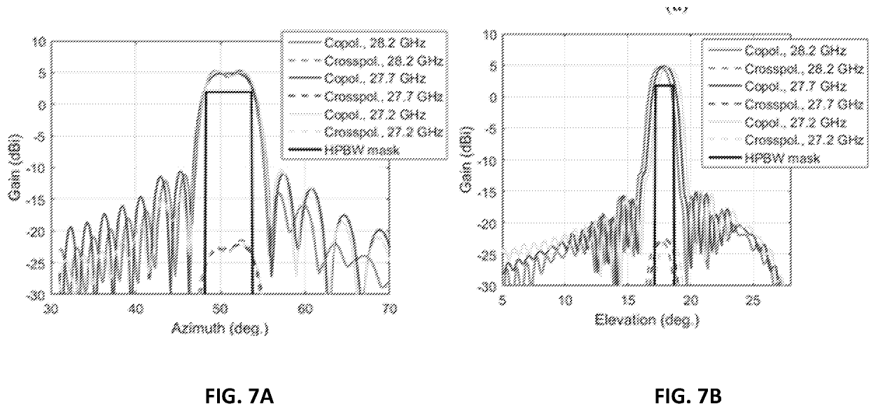

The performance of the reflectarray has been evaluated within the 27.2-28.2 GHz band used for 5G communications. The comparison of the radiation patterns in V-polarization at the central and extreme frequencies as illustrated below. FIGS. 7A and 7B illustrate radiation patterns in azimuth and elevation planes (e.g., for both azimuth and elevation cuts) of a reflectarray at different operating frequencies, in accordance with various implementations of the subject technology. The reflectarray exhibits a stable performance in the operation band, keeping similar levels of side lobes and cross-polar components. There is only a small beam squint in elevation)(±0.25°, which can be reduced by a more refined design of the reflectarray. The results for H-polarization are very similar to those in FIGS. 7A and 7B for V-polarization.

A passive dual-polarized shaped-beam reflectarray has been proposed in this work to enhance wireless coverage in 5G cellular networks. The RA has been designed to generate a broadened beam which is deviated 18° in elevation with respect to the specular direction of the BS. The RA provides the same radiation pattern in H and V polarizations, showing a satisfactory performance within the 27.2-28.2 GHz band used for 5G communications. The results of the simulations confirm the potential of RA antennas for this application.

In accordance with various embodiments and implementations, the reflectarray can have a dimension of 80 cm×40 cm, or 40 cm×40 cm. Accordingly, based on the size of the reflectarray, the number of cells (or elements as referred to herein) can be 178×90 or 90×90, respectively, depending on the operation frequency of the reflectarray.

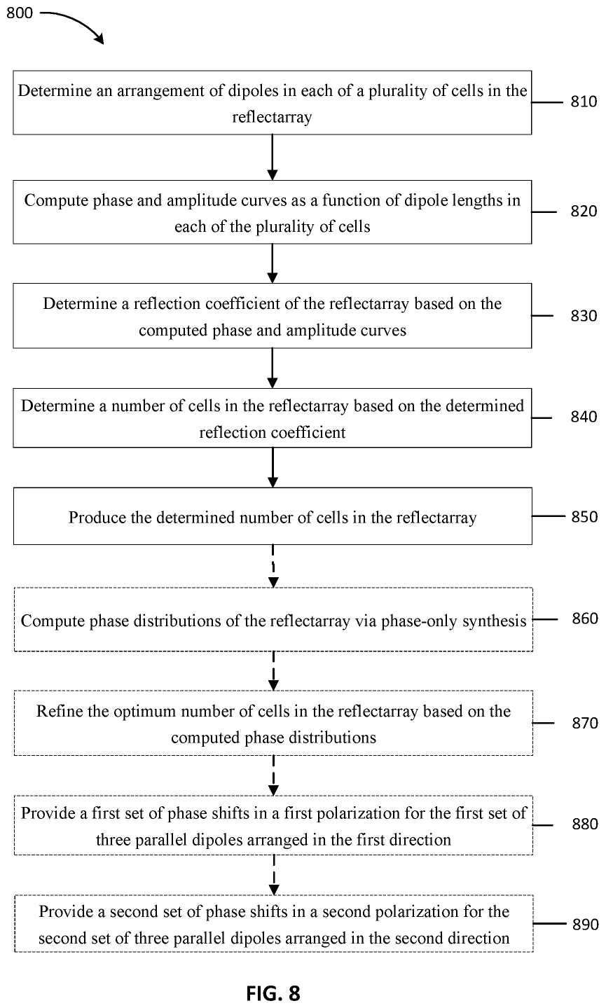

FIG. 8 illustrates a flowchart for a process 800 of designing a reflectarray, in accordance with one or more implementations of the subject technology. The process 800 for designing the reflectarray includes, at step 810, determining an arrangement of dipoles in each of a plurality of cells in the reflectarray; at step 820, computing phase and amplitude curves as a function of dipole lengths in each of the plurality of cells; at step 830, determining a reflection coefficient of the reflectarray based on the computed phase and amplitude curves; at step 840, determining an optimum number of cells in the reflectarray based on the determined reflection coefficient; and at step 850, producing the determined number of cells in the reflectarray.

In various embodiments, the process optionally includes, at step 860, computing phase distributions of the reflectarray via phase-only synthesis; and optionally includes, at step 870, refining the number of cells in the reflectarray based on the computed phase distributions. In various embodiments, the producing includes printing the determined number of cells in the reflectarray. In various embodiments, the arrangement of dipoles includes a parallel configuration of three dipoles with a length of a center dipole is longer than a length of a lateral dipole. In various embodiments, the length of the lateral dipole is 65% of the length of the center dipole. In various embodiments, the plurality of cells includes a first set of three parallel dipoles arranged in a first direction and a second set of three parallel dipoles in a second direction orthogonal to the first direction.

In various embodiments, the process optionally includes, at step 880, providing a first set of phase shifts in a first polarization for the first set of three parallel dipoles arranged in the first direction; and at step 890, providing a second set of phase shifts in a second polarization for the second set of three parallel dipoles arranged in the second direction.

In accordance with various embodiments and implementations, a reflectarray is described. The reflectarray can be deployed in an antenna system for wireless communications, such as in 5G networks. The reflectarray includes a substrate and a plurality of cells configured in an array on the substrate. Each cell in the plurality of cells can include at least three dipoles arranged in a parallel configuration with a length of a center dipole longer than a length of a lateral dipole.

In various embodiments, the plurality of cells includes a first set of three parallel dipoles arranged in a first direction and a second set of three parallel dipoles in a second direction. In various embodiments, the first direction and the second direction are orthogonal to one another. In various embodiments, the first set of three parallel dipoles and the second set of three parallel dipoles are shifted half a period along both the first direction and the second direction in the array. In various embodiments, lengths of the first set of three parallel dipoles and the second set of three parallel dipoles are configured to provide phase shifts in two orthogonal polarizations. In various embodiments, the length of the lateral dipole is between 20% to 90% of the length of the center dipole. In various embodiments, the length of the lateral dipole is 65% of the length of the center dipole. In various embodiments, a separation between adjacent dipoles in the at least three dipoles is between 0.5 mm to 1 mm and a width of each the at least three dipoles is about 0.1 mm to about 0.5 mm.

In accordance with various embodiments and implementations, a process for designing a reflectarray is described. The process includes determining an arrangement of dipoles in each of a plurality of cells in the reflectarray; computing phase and amplitude curves as a function of dipole lengths in each of the plurality of cells; determining a reflection coefficient of the reflectarray based on the computed phase and amplitude curves; determining a number of cells in the reflectarray based on the determined reflection coefficient; and producing the determined number of cells in the reflectarray.

In various embodiments, the process further includes computing phase distributions of the reflectarray via phase-only synthesis; and refining the number of cells in the reflectarray based on the computed phase distributions. In various embodiments, the producing includes printing the determined number of cells in the reflectarray. In various embodiments, the arrangement of dipoles includes a parallel configuration of three dipoles with a length of a center dipole is longer than a length of a lateral dipole. In various embodiments, the length of the lateral dipole is 65% of the length of the center dipole. In various embodiments, the plurality of cells comprises a first set of three parallel dipoles arranged in a first direction and a second set of three parallel dipoles in a second direction orthogonal to the first direction. In various embodiments, the process further includes providing a first set of phase shifts in a first polarization for the first set of three parallel dipoles arranged in the first direction; and providing a second set of phase shifts in a second polarization for the second set of three parallel dipoles arranged in the second direction.

In accordance with various embodiments and implementations, an antenna system for wireless communications. The antenna system includes a base station configured for sending a signal beam and a reflectarray configured for reflecting the signal beam to a non-line of sight area. The reflectarray can include a plurality of cells each comprising three parallel dipoles arranged in a parallel configuration.

In various embodiments, the reflectarray includes a first set of three parallel dipoles arranged in a first direction and a second set of three parallel dipoles in a second direction orthogonal to the first direction. In various embodiments, the first set of three parallel dipoles and the second set of three parallel dipoles can be shifted half a period along both the first direction and the second direction in the array.

In various embodiments, the three parallel dipoles arranged in the parallel configuration comprises a lateral dipole with a length that is between 20% to 90% of a length of a center dipole. In various embodiments, a separation between adjacent dipoles in the three parallel dipoles is between 0.5 mm to 1 mm and a width of each of the three parallel dipoles is about 0.1 mm to about 0.5 mm.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A reflectarray, comprising:
a substrate; and
a plurality of cells configured in an array on the substrate, each cell in the plurality of cells comprising at least three dipoles arranged in a parallel configuration with a length of a center dipole longer than a length of a lateral dipole.

2. The reflectarray of claim 1, wherein the plurality of cells comprises a first set of three parallel dipoles arranged in a first direction and a second set of three parallel dipoles in a second direction.

3. The reflectarray of claim 2, wherein the first direction and the second direction are orthogonal to one another.

4. The reflectarray of claim 2, wherein the first set of three parallel dipoles and the second set of three parallel dipoles are shifted half a period along both the first direction and the second direction in the array.

5. The reflectarray of claim 2, wherein lengths of the first set of three parallel dipoles and the second set of three parallel dipoles are configured to provide phase shifts in two orthogonal polarizations.

6. The reflectarray of claim 1, wherein the length of the lateral dipole is between 20% to 90% of the length of the center dipole.

7. The reflectarray of claim 1, wherein the length of the lateral dipole is 65% of the length of the center dipole.

8. The reflectarray of claim 1, wherein a separation between adjacent dipoles in the at least three dipoles is between 0.5 mm to 1 mm and a width of each the at least three dipoles is about mm to about 0.5 mm.

9. A process for designing a reflectarray, comprising:
determining an arrangement of dipoles in each of a plurality of cells in the reflectarray;
computing phase and amplitude curves as a function of dipole lengths in each of the plurality of cells;
determining a reflection coefficient of the reflectarray based on the computed phase and amplitude curves;
determining a number of cells in the reflectarray based on the determined reflection coefficient; and
producing the determined number of cells in the reflectarray.

10. The process of claim 9, further comprising:
computing phase distributions of the reflectarray via phase-only synthesis; and
refining the number of cells in the reflectarray based on the computed phase distributions.

11. The process of claim 9, wherein the producing comprises printing the determined number of cells in the reflectarray.

12. The process of claim 9, wherein the arrangement of dipoles comprises a parallel configuration of three dipoles with a length of a center dipole is longer than a length of a lateral dipole.

13. The process of claim 12, wherein the length of the lateral dipole is 65% of the length of the center dipole.

14. The process of claim 9, wherein the plurality of cells comprises a first set of three parallel dipoles arranged in a first direction and a second set of three parallel dipoles in a second direction orthogonal to the first direction.

15. The process of claim 14, further comprising:
providing a first set of phase shifts in a first polarization for the first set of three parallel dipoles arranged in the first direction; and
providing a second set of phase shifts in a second polarization for the second set of three parallel dipoles arranged in the second direction.

16. An antenna system for wireless communications, comprising:
a base station configured for sending a signal beam; and
a reflectarray configured for reflecting the signal beam to a non-line of sight area, wherein the reflectarray comprises a plurality of cells each comprising three parallel dipoles arranged in a parallel configuration.

17. The antenna system of claim 16, wherein the reflectarray comprises a first set of three parallel dipoles arranged in a first direction and a second set of three parallel dipoles in a second direction orthogonal to the first direction.

18. The antenna system of claim 17, wherein the first set of three parallel dipoles and the second set of three parallel dipoles are shifted half a period along both the first direction and the second direction in the array.

19. The antenna system of claim 16, wherein the three parallel dipoles arranged in the parallel configuration comprises a lateral dipole with a length that is between 20% to 90% of a length of a center dipole.

20. The antenna system of claim 16, wherein a separation between adjacent dipoles in the three parallel dipoles is between 0.5 mm to 1 mm and a width of each of the three parallel dipoles is about 0.1 mm to about 0.5 mm.
